(19) United States
(12) Patent Application Publication
(10) Pub. No.: US 2005/0103281 A1
(43) Pub. Date: May 19, 2005

(54) Sweat scraper

(76) Inventors: Augusto A. Picozza, Boca Raton, FL (US); Thomas Swyst, Arlington, MA (US); John Devlin, Tewksbury, MA (US); Gustavo Fontana, Cambridge, MA (US)

Correspondence Address: Lawrence J. Shurupoff;Sunbeam Products, Inc., 2381 Executive Center Drive, Boca Raton, FL, 33431, US

(21) Appl. No.: 10/699,378

(22) Filed: Oct. 30, 2003

(51) Int. Cl. A01K 13/00

(52) U.S. Cl. 119/623

(57) ABSTRACT

A sweat scraper includes a core made of a first resilient material defining a scraper blade and a handle. A sheath made of a second resilient material substantially surrounds the side edges of the core and defines a continous border around the scraper blade edges. The first resilient material is preferably substantially less resilient than the second resilient material to form a compliant continues unshaped wiper blade.

### BACKGROUND OF THE DISCLOSURE

1. Field of the Disclosure

The present invention relates to devices for scraping sweat and debris off animals, particularly horses, and relates in particular to a scraper having a rigid frame and a flexible overmolded scraping blade and overmolded handle.

2. Description of the Related Art

Equine sweat scrapers have been known in the art of horse grooming for quite some time, as evidenced by the patent issued Jan. 12, 1886 to Sanford, G. W., U.S. Pat. No. 334,198, for a SWEAT SCRAPER FOR HORSES. Sanford discloses a curved blade formed by trapping a blade of rubber between two metal strips. The metal strips provide stiffness, and the soft rubber provides the wiper blades. As sweat is both wet and salty, it is likely Sanford's metal strips were prone to corrosion.

More popular, and still sold in tack shops to this very day, are variants on Anderson, W. A., U.S. Pat. No. 1,141,917, for a SCRAPER, issued Jun. 18, 1915. Anderson's disclosure describes an elongated metal scoop. Similar plastic versions may be obtained from equestrian suppliers such as G. T. Reid Equestrian Sales, Oilville, Va., under product Nos. 09435 and 09129. A “ball-handled” version designed for a better grip is sold under product No. 09346.

Also known are “squeegee” type sweat scrapers where the handle is perpendicular to the blade. Some groomers find these awkward to use, particularly over the top of the horse where it is difficult to reach.

Also commonly known are simple wooden scrapers that are little more than elongated spatula-like devices.

There are a number of problems with the known art, the primary one being that these devices are often made of a single material. This presents a problem because the material requirements for blade stiffness are quite different than that for the blade edges that do the actual scraping. Just as on the windshield wiper of a car, it is adventageous to have a good stiff support for a soft rubbery blade edge that will conform to the surface being wiped.

Another problem with the known art is in the low friction material handles provided to hold these blades. Often, particularly after a polo match or other competitive endeavor, the rider of the horse is sweating just as much as the horse. Smooth-handled devices tend to slip and rotate in the user's sweaty hands as the instrument is stroked across the animal. A better ergonomic design is desired for the handles.

### BRIEF SUMMARY OF THE DISCLOSURE

The present invention is directed to a sweat scraper having a core made of a first resilient material defining a scraper blade and a handle, and a sheath made of a second resilient material, The sheath substantially enveloping said core and defining scraper blade edges. The first resilient material is substantially less resilient than the second resilient material to provide a rigid support for the softer scraper blades.

In another aspect of the scraper, the scraper blade is curved to match the contours of a horse.

In another aspect of the scraper, a soft overmolded sheath covers at least a portion of the handle. A particular advantage of the present invention is the use of a single overmolded material to simultaneously form a resilient compliant scraping blade and a relatively soft compliant cover over the handle to improve its feel and serve as a slip resistant grip.

In another aspect of the scraper, the first resilient material is a polymer, such as polypropylene.

In another aspect of the scraper, the second resilient material is a polymer, such as rubber.

In another aspect of the scraper, the second resilient material is a silicon rubber.

In another aspect of the scraper, the second resilient material is an ethylene propylene diene monomer rubber.

In another aspect of the scraper, the second resilient material is a thermoplastic vulcanate.

In another aspect of the scraper, the second resilient material includes an ethylene propylene diene monomer rubber and a polymer.

In another aspect of the scraper, the second resilient material includes an ethylene propylene diene monomer rubber and polypropylene.

The present invention also includes a method of manufacturing a sweat scraper by forming a core of a first material in a shape defining a handle and a blade, overmolding onto the core a sheath of a second material defining scraper blade edges and, preferably an overmolded sheath providing an improved grip on the handle, and wherein the first material is substantially less resilient than the second material.

In another aspect of the method, the blade of the core is provided with interlocking edges to interlock with and secure the scraper blade edges to the core.

### BRIEF DESCRIPTION OF THE DRAWINGS

FIG. 1 is a perspective view of an embodiment of a sweat scraper contructed in accordance with the invention.

FIG. 1a is a view directly down the longitudinal axis of the blade of the scraper of FIG. 1, as viewed from the blade tip toward the handle.

FIG. 1b is a view looking directly at the end of the handle of the scraper of FIG. 1, as viewed from the handle toward the blade tip.

FIG. 1c is an enlarged fragmental view of an embodiment of the shape of a blade edge taken from section 1c of FIG. 1a.

FIG. 2 is a top plan view of the scraper of FIG. 1.

FIG. 3 is a left side view of the scraper of FIG. 1.

FIG. 4 is a bottom view of the scraper of FIG. 1 and showing an optional hanging hole in the blade tip.

FIG. 5 is a left side (longitudinal) cross-sectional view of the scraper of FIG. 1 taken along section line 5-5 of FIG. 2.

FIGS. 5a and 5b are enlarged fragmental views of the blade and handle tips, respectively, taken from sections 5a and 5b of FIG. 5.

FIG. 6 is a transverse cross sectional view of the blade of the scraper of FIG. 1, taken along section line 6-6 of FIG. 2.

### DETAILED DESCRIPTION OF THE PREFERRED EMBODIMENTS

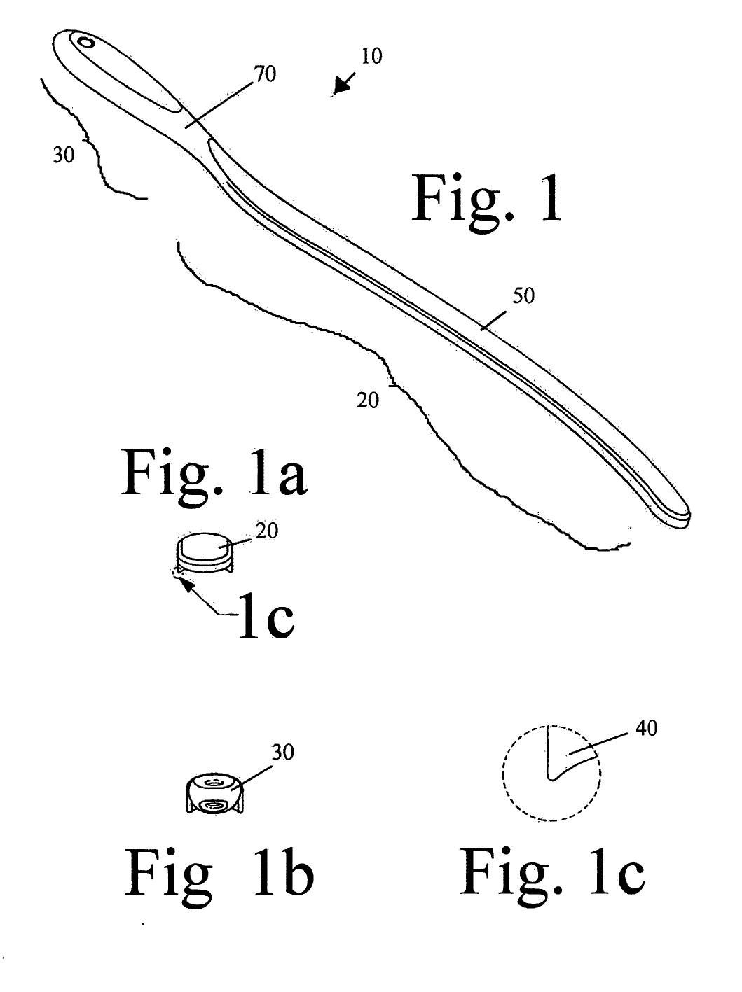

Referring to FIG. 1, there is shown an embodiment of a sweat scraper 10 constructed in accordance with the present invention. Super 10 includes an elongated trough-shaped blade 20 and a handle 30 disposed at one end of the blade 20. FIG. 1a shows the front end of the scraper 10 as seen looking directly down the blade 20, while FIG. 1b shows the rear end of the scraper 10 looking directly at the rear of the handle 30. FIG. 1c is a close-up of a blade edge 40.

The scraper 10 is constructed of two components made of materials of different physical properties. The first is a core 50 made of a first semi-rigid resilient material, which defines the scraper blade 20 and handle 30. The second is a sheath 70 made of a second resilient material that substantially envelops at least a portion of the core 50. The sheath 70 defines the blade edges 40 that do the actual scraping by sliding over an animal's coat.

The core 50 is made of a stiffer, less resilient first material than that of the sheath 70 so as to provide structural rigidity. Preferred first materials include polymers, such as polyethylene, polypropylene, and the like. The sheath 70 is formed of a softer second material that permits the blade edges 40 to conform to the surface being scraped. The sheath 70 is preferably made of a material that provides high friction contact with the human hand for a secure grip. It is preferred that the sheath extend over a substantial portion of the handle 30 for this purpose.

The second material used for the sheath and blade edges is preferably “rubbery,” such as, for example, simple natural or synthetic rubbers, silicon rubber, polychloroprene rubbers, and thermoplastic elastomers (TPE), such as ethylene propylene diene monomer (EPDM) rubbers, and the like. These rubbers may be blended with polymers as needed to obtain the desired physical characteristics. A preferred second material is thermoplastic vulcanates (TPV) including finely divided rubber particles, either partially or fully cross-linked, which are commercially available and sold under the tradenames SANTOPRENE and VYRAM by Advanced Elastomer Systems of Akron, Ohio. Also usable are thermoplastic vulcanates (TPV) including finely divided rubber particles in a thermoplastic matrix, such as those sold under the tradename VYRAM, also by Advanced Elastomer Systems.

A preferred material for the sheath 70 is TPV designated by the product codes SANTOPRENE 201-55 and VYRAM 9201-55, both of which include an EPDM rubber blended into a polypropylene matrix, which demonstrate a durometer hardness (A Scale, 5 seconds) of 55 using an ASTM D2240 test method and tensile strengths of 638 psi and 522 psi (ASTM D412), respectively. The VYRAM product is less expensive because the EPDM rubber component is not fully crosslinked as it is in the SANTOPRENE product. For the core 50, a polypropylene designated by product code PP K1011 sold by Formosa Chemicals of Taiwan is effective.

In molding manufacture of the sweat scraper 10, polypropylene and the TPV bind extremely tightly to one another when the sheath 70 is molded onto the core 50. Hence, a preferred method of manufacture is to first mold the polypropylene core and then transfer it to another mold into which the molten TPV is injected. This method is commonly referred to in the industry as “overmolding.”

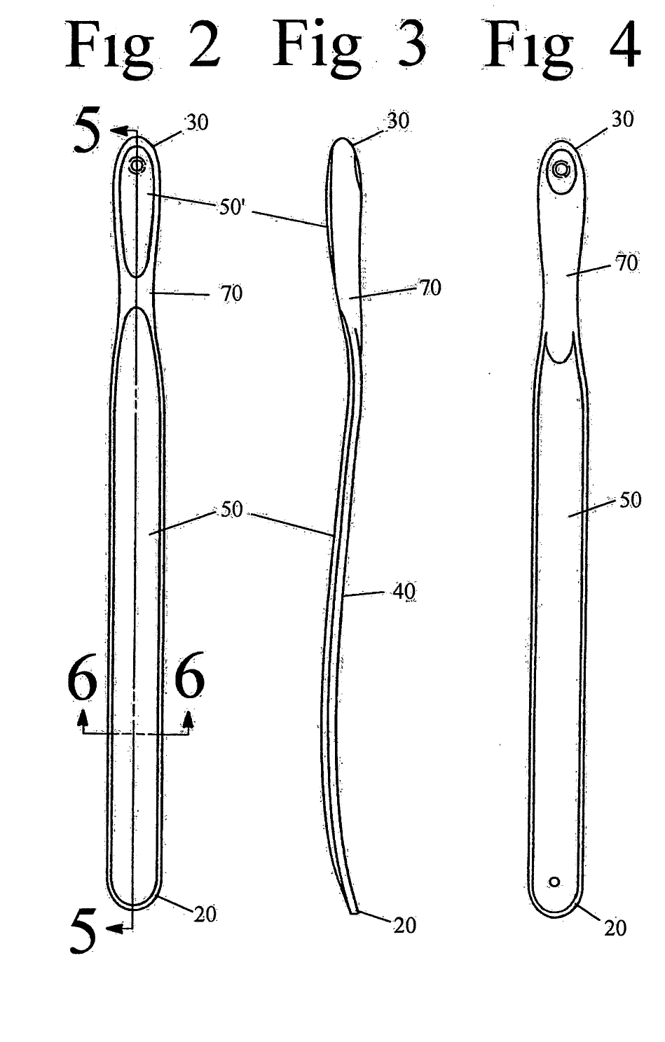

FIG. 2 is a top plan view of the scraper 10 of FIG. 1. The upper surface 50a of the handle 30 is preferably not covered by the sheath. This is because rubbery materials can feel uncomfortable in the palm of the hand. In FIG. 4 it is seen that the bottom of the handle 30 is preferable completely covered to provide a secure grip for the thumb and fingers. Preferably, the exposed core material will present lower friction than the sheath material so that the palm of the hand may slide around relatively freely as the user adjusts the user's fingers around the handle in a similar manner as that described in the commonly assigned copending application entitled GROOMING BRUSH, Docket No. SUNHPRO-2-4301, filed on even date herewith, the disclosure of which is incorporated by reference herein in its entirety. Polypropylene is well suited as the core material, as are other low friction polymers, such as polyethylene, polybutylene, and the like.

Referring to FIGS. 2-4, it can be seen that the scraper blade 20 need not be completely covered by the sheath 70 material. The only sheathing needed for the blade is that necessary to provide the softer scraper blade edges 40. This saves on material costs. It also allows for an esthetically pleasing design because the core 50 and sheath 70 materials may be of different colors, if desired.

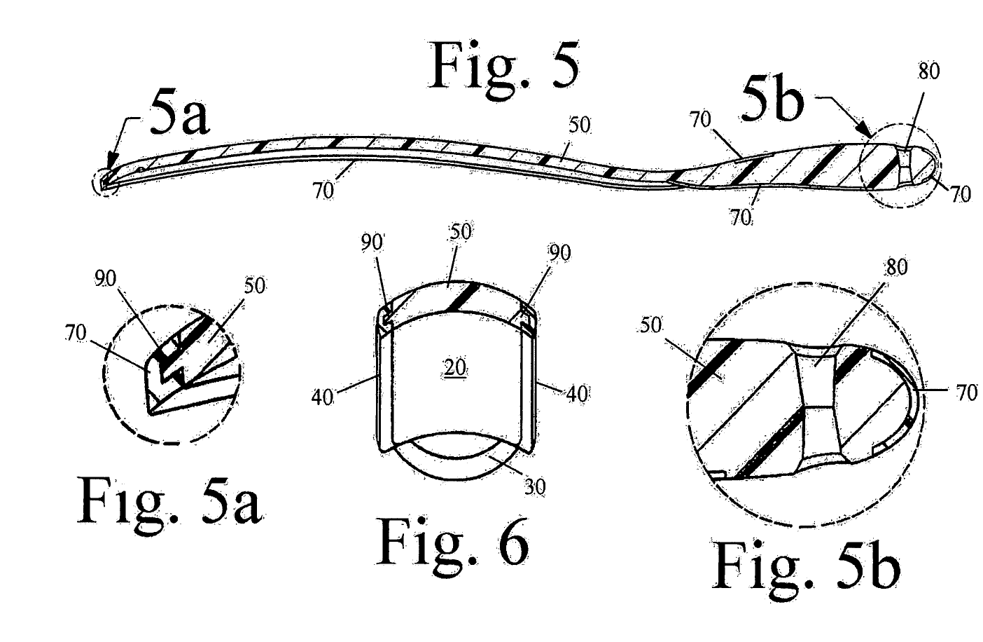

As can be seen in FIG. 3, the blade 20 is curved to compliment and match the surface to be scraped. Of course, animals have many differently curved surfaces, but for a horse, a gentle curve is adequate. Referring to FIG. 5, there is shown the scraper 10 of the previous Figures in cross-section. The relatively rigid core 50 of a preferably inexpensive material (e.g., polypropylene) requires only a thin sheathing of a likely more expensive sheath material 70 (e.g., TPV).

As can be seen in FIG. 5b, it may be desirable to define an opening 80 in the blade for hanging the device on a nail in a wall or for running through a string or strap through that may be tied in a loop for hanging purposes. As seen in FIG. 4, a mounting hole may also be formed through the tip of the blade 20.

FIG. 6 is a cross-section of the blade taken through section line 6-6 of FIG. 2. Costs can be reduced by eliminating the sheeting material 70 from the top and bottom surfaces of the blade 20 and by limiting its application to the blade edges 40. It is desirable to provide some form of interlocking edge 90 (FIG. 5a) to the blade to physically keep the blade edges 40 anchored in position and to provide greater surface area for bonding of the blade edges 40 to the blade 20 during the molding process. Also shown in FIG. 5a, the core 50 is molded with a tongue 90 along its entire periphery to form a keyed lock or tongue and groove interconnection with the blade edge 40.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

1. An animal sweat scraper adapted to scrape sweat from an animal, comprising:
a core made of a first resilient material, said core defining an elongated curved scraper blade shaped to remove sweat and debris from an animal, and a handle extending from one end of said scraper blade;
a sheath made of a second resilient material, said sheath provided on said core and along a length of said scraper blade defining scraper blade edges adapted to scrape sweat from an animal; and
wherein said first resilient material is less resilient than said second resilient material.

2. (canceled)

3. (canceled)

4. The sweat scraper of claim 1 wherein said first resilient material comprises a polymer.

5. The sweat scraper of claim 4 wherein said first resilient material comprises polypropylene.

6. The sweat scraper of claim 1 wherein said second resilient material comprises a polymer.

7. The sweat scraper of claim 6 wherein said second resilient material comprises a rubber.

8. The sweat scraper of claim 7 wherein said second resilient material comprises a silicon rubber.

9. The sweat scraper of claim 7 wherein said second resilient material comprises an ethylene propylene diene monomer rubber.

10. The sweat scraper of claim 1 wherein said second resilient material comprises a thermoplastic vulcanate.

11. The sweat scraper of claim 10 wherein said second resilient material comprises an ethylene propylene diene monomer rubber and a polymer.

12. The sweat scraper of claim 10 wherein said second resilient material comprises an ethylene propylene diene monomer rubber and polypropylene.

13. The sweat scraper of claim 1, wherein said blade comprises an elongated trough-shaped blade.

14. The sweat scraper of claim 1, further comprising an interlock formed between said scraper blade and said sheath.

15. The sweat scraper of claim 14, wherein said interlock comprises a tongue and groove interlock.

16. (canceled)

17. (canceled)

18. (canceled)
